(19) United States
(12) Patent Application Publication
(10) Pub. No.: US 2008/0269433 A1
(43) Pub. Date: Oct. 30, 2008

(54) Process for the Carbonylation of a Conjugated Diene

(76) Inventors: Eit Drent, Amsterdam (NL); Rene Ernst, Amsterdam (NL); Willem Wabe Jager, Amsterdam (NL); Cornelia Alida Krom, Amsterdam (NL); Timothy Michael Nisbet, Amsterdam (NL)

Correspondence Address: SHELL OIL COMPANY, P O BOX 2463, HOUSTON, TX, 772522463, US

(21) Appl. No.: 11/884,107

(22) PCT Filed: Feb. 10, 2006
(86) PCT No.: PCT/EP2006/050825

§ 371 Date: May 21, 2008

(30) Foreign Application Priority Data
Feb. 11, 2005 (EP) 05101018.9

(51) Int. Cl. C08F 2/60

(52) U.S. Cl. 526/68

(57) ABSTRACT

A process for the carbonylation of a conjugated diene to an ethylenically unsaturated acid, comprising the steps of (a) contacting a conjugated diene with carbon monoxide and water in the presence of a catalyst system including a source of palladium, a source of an anion and a bidentate phosphine ligand, to obtain a mixture comprising an ethylenically unsaturated acid and a reversible diene adduct comprising alkenyl ester of the conjugated diene with the ethylenically unsaturated acid; (b) separating the obtained reaction mixture into a gaseous stream comprising unreacted conjugated diene and carbon monoxide, a first liquid product stream comprising at least part of the ethylenically unsaturated acid and the reversible diene adducts, and a second liquid stream comprising the catalyst system in admixture with the ethylenically unsaturated acid; (c) separating the first liquid product stream obtained in step (b) into a stream comprising the ethylenically unsaturated acid and a stream comprising the reversible diene adducts; and (d) recycling the stream comprising the reversible diene adducts to step (a), or converting the reversible diene adducts back to the conjugated diene and the ethylenically unsaturated acid and recycling the thus obtained conjugated diene to step (a).

### FIELD OF THE INVENTION

The present invention provides a process for the carbonylation of a conjugated diene to an ethylenically unsaturated acid.

### BACKGROUND OF THE INVENTION

Carbonylation reactions of conjugated dienes are well known in the art. In this specification, the term carbonylation refers to a reaction of a conjugated diene under catalysis by a transition metal complex in the presence of carbon monoxide and water, as for instance described in WO 04/103948.

In WO 04/103948, a process is disclosed for the preparation of adipic acid from 1,3-butadiene or a mixture of 1,3-butadiene with olefinic products in a two-stage reaction. In the first stage of the disclosed process, 1,3-butadiene was reacted with carbon monoxide and water in the presence of a carbonylation catalyst comprising a palladium compound, a source of an anion and 1,2-bis(di-tert-butylphosphinomethyl)benzene as bidentate diphosphine ligand for several hours until substantially all of the 1,3-butadiene was converted to a mixture of 2- and 3-pentenoic acid, with minor amounts of 4-pentenoic acid. It was found that this reaction requires long reaction times or the use of large reactors in the case of a continuous operation, which makes it less suitable for industrial applicability. Moreover, the catalyst is exposed to the reaction temperature for a prolonged period of time without participating in any carbonylation reaction. This decreases the overall catalyst activity, and hence efficiency, since the catalyst slowly degrades upon exposure to higher temperatures.

Accordingly, there remained the need to provide for a process for the preparation of ethylenically unsaturated acids, wherein good use is made of the catalyst activity, thereby making the process more efficient, and thus more attractive for industrial application. It has now been found that the above identified process for the preparation of a unsaturated acid products from a conjugated diene can be very effectively performed as set out below, which makes it particularly suited as a semi-continuous or continuous industrial scale process.

### SUMMARY OF THE INVENTION

Accordingly, the subject invention provides a process for the carbonylation of a conjugated diene to an ethylenically unsaturated acid, comprising the steps of (a) contacting a conjugated diene with carbon monoxide and water in the presence of a catalyst system including a source of palladium, a source of an anion and a bidentate phosphine ligand, to obtain a mixture comprising an ethylenically unsaturated acid and a reversible diene adduct comprising alkenyl esters of the conjugated diene with the ethylenically unsaturated acid; (b) separating the obtained reaction mixture into a gaseous stream comprising unreacted conjugated diene and carbon monoxide, a first normally liquid product stream comprising at least part of the ethylenically unsaturated acid and the reversible diene adducts, and a second normally liquid stream comprising the catalyst system in admixture with the ethylenically unsaturated acid; (c) separating the first normally liquid product stream obtained in step (b) into a stream comprising the ethylenically unsaturated acid and a stream comprising the reversible diene adducts; and (d) recycling the stream comprising the reversible diene adducts to step (a), or converting the reversible diene adducts back to the conjugated diene and the ethylenically unsaturated-acid and recycling the thus obtained conjugated diene to step (a).

### DETAILED DESCRIPTION OF THE INVENTION

Applicants found that by partly converting the conjugated diene starting compound in step (a) and by separating non-converted conjugated diene and reversible adducts formed by the conjugated diene from the mixture comprising the catalyst system and the intermediate ethylenically unsaturated product, a very efficient process is obtained. By not allowing the reaction in step (a) to proceed to full conversion, long reaction times are avoided, which make the subject process economical. In contrast to the process disclosed in WO 04/103948, this permits to maintain high turn-over numbers and high turn-over frequencies throughout the process, since the reaction to full conversion of the conjugated diene, e.g. 1,3-butadiene, becomes very slow in particular towards the end of the reaction when most butadiene has been converted. Additionally, in the process according to the present invention, the catalyst can be conveniently recycled in a liquid stream to process step (a), without exposing the catalyst to high temperatures to prolonged periods of time.

The subject process is based on the insight that the catalyst system hardly converts any of the obtained ethylenically unsaturated acid before the conjugated diene present in the reaction mixture is converted, although the catalyst system is in principle capable of converting the ethylenically unsaturated product with good reactivity. In the case of 1,3-butadiene as conjugated diene, the term ethylenically unsaturated acid product describes 2-pentenoic acid, 3-pentenoic acid and 4-pentenoic acid, and mixtures thereof.

A further advantage of the subject process resides in the fact that the high selectivity for conjugated dienes in the first step of the process has the advantage that the feed containing the diene reactant does not necessarily have to be free of alkenes or even alkynes. Even an admixture with up to 55 mol % of alkenes and/or alkynes based on the conjugated diene was tolerated in the feed without significant occurrence of carbonylation products of the alkenes or alkynes. Accordingly, in a further aspect, the subject invention thus preferably relates to a process for the selective separation and conversion of a conjugated diene from a feed containing the conjugated diene in admixture with alkenes and/or alkynes, comprising contacting the feed with carbon monoxide and water in the presence of a catalyst system including a source of palladium, a source of an anion and a bidentate phosphine ligand to obtain a mixture depleted of the conjugated diene and comprising an ethylenically unsaturated acid and reversible diene adducts comprising alkenyl ester of the conjugated diene with the ethylenically unsaturated acid. The mixture obtained in this reaction may then advantageously be separated into a stream containing the alkenes and/or alkynes, and a stream comprising the ethylenically unsaturated acid and reversible diene adducts in admixture with the catalyst system. The latter mixture may then preferably be subjected to step (b) and (c) of the subject process.

In step (a) of the subject process, it was found that conjugated dienes have the tendency to reversibly form allylic alkenyl esters with any sufficiently reactive carboxylic acid present in the reaction mixture, in particular under catalysis by the carbonylation catalyst.

Depending on the reaction conditions, such alkenyl esters can be formed in substantial amounts.

Without wishing to be bound to any particular theory, it is believed that the formation of the esters from the conjugated diene and the ethylenically unsaturated acid is an equilibrium reaction catalyzed by the carbonylation catalyst, albeit at a comparatively slow rate. The presence of a high conjugated diene concentration, as well as an increasing amount of a carboxylic acid favours the formation of esters. In absence of catalyst, the equilibrium reaction becomes very slow, hence effectively freezing the equilibrium.

Since the alkenyl esters can be reverted into the conjugated diene and the ethylenically unsaturated acid, they are referred to as “reversible diene adducts” throughout the present specification. These “reversible diene adducts” were found to be remarkably stable in absence of the carbonylation catalyst.

In the case of 1,3-butadiene as conjugated diene, the “reversible diene adducts” are the butenyl esters with any suitable reactive carboxylic acid present in the reaction mixture, thus mainly butenyl esters of 2-, 3- and 4-pentenoic acid, and mixtures thereof. Obviously, other acids present in the mixture react as well with the conjugated diene, and thus form reversible diene adducts as well.

During the carbonylation reaction in step (a), the reaction medium will be increasingly depleted of the conjugated diene towards the end of the reaction. It was observed in a batch reaction that the concentration of the conjugated diene very slowly approached a minimum concentration, while not falling below this minimum concentration for a considerable amount of time.

Without wishing to be bound to any particular theory, it is believed that this is due to the presence of reversible diene adducts, which slowly revert back to the conjugated diene and the acid to which they stand in equilibrium under catalysis by the palladium carbonylation catalyst. Accordingly, the overall reaction rate becomes increasingly dependent on speed of the reversion of the reversible diene adducts to conjugated diene and acid.

In order to avoid arriving at a low concentration of conjugated diene, step (a) of the present process is preferably not allowed to proceed to full conversion of conjugated diene and its reversible adducts, but only to partial conversion. Then any remaining conjugated diene and reversible adducts are preferably removed from the reaction mixture prior to, or during step (b), together with any remaining conjugated diene. Step (a) is preferably allowed to proceed to 99% of conversion, based on moles of conjugated diene converted versus moles of conjugated diene fed. Yet more preferably, step (a) is allowed to proceed to 85% of conversion, again more preferably to 75% of conversion, again more preferably step to 65% of conversion, and most preferably step (a) is allowed to proceed to 60% of conversion. Again more preferably, the reaction is conducted in such way; the conversion of conjugated diene, in particular 1,3-butadiene, is in step (a) in the range of from 30 to 60%, based on moles of conjugated diene converted versus moles of conjugated diene fed.

In step (a), the ratio (v/v) of conjugated diene and water in the feed can vary between wide limits and suitably lies in the range of 1:0.0001 to 1:500. However, it was found that the addition of water in step (a) to the reaction medium in order to provide a higher concentration of the reactant and hence an increased reaction rate had the opposite effect, i.e. an increase of the water concentration resulted in a strongly decreased reaction rate. Therefore, preferably, in step (a), less than 3% by weight of water is present in the reactor, yet more preferably, less than 2% by weight of water, yet more preferably, less than 1% by weight of water, again more preferably less than 0.15% by weight of water, and most preferably from 0.001% to less than 3% by weight of water (w/w) is present in the reactor, calculated on the total weight of reactants. Again more preferably, these water concentrations are maintained continuously at this level, in particular if the reaction is performed as semi-batch or as continuous process. The water concentration may be determined by any suitable method, for instance by a Karl-Fischer-titration.

Subsequently, in step (b), the reaction mixture obtained in step (a) is separated into a gaseous stream comprising unreacted conjugated diene and carbon monoxide, a first normally liquid stream comprising at least part of the ethylenically unsaturated acid and the reversible diene adducts, and a second normally liquid stream comprising the catalyst system in admixture with the ethylenically unsaturated acid.

The second normally liquid stream comprising the catalyst system in admixture with ethylenically unsaturated acid obtained in step (b) is preferably recycled to step (a).

Step (b) may be performed by any known suitable separation method. Preferably, step (b) is performed as a distillative separation. More preferably, the distillative separation of the first normally liquid product stream, and the second normally liquid product stream is performed as a flash separation under reduced pressure. If 1,3-butadiene is the conjugated diene, the flash separation is preferably performed at a bottom temperature in range of from 70 to 150° C. and a pressure of from 1 to 30 kPa (10 to 300 mbar), yet more preferably at a bottom temperature in range of from 90 to 130° C. and a pressure of from 2.5 to 15 kPa, and most preferably, at a bottom temperature in the range of from 100 to 110° C. and at a pressure in the range of from 3 to 8 kPa. Although these pressures and temperatures are not critical, pressures of above 20 kPa should be avoided due to the high temperatures required, which may result in catalyst degradation, while pressures below 1 kPa will require specific equipment. Preferably, the flash separation is performed in a film evaporator, more preferably in a falling film or wiped film evaporator, since these allow high throughput and short catalyst residence time.

The first normally liquid product stream obtained in step (b) comprises ethylenically unsaturated acid formed in step (a), as well as the reversible diene adducts. The amount of ethylenically unsaturated acid in this stream is limited solely by the catalyst concentration remaining in the second normally liquid stream, which is the bottom stream. If too much ethylenically unsaturated acid is removed from the bottom stream, then catalyst degradation may occur in the remaining concentrate, or catalyst components or side-products can crystallize and obstruct the recycling operation. Preferably, in a continuous process, at least 5% (w/w) of the ethylenically unsaturated acid is comprised in the first liquid stream, while the remaining 95% (w/w) remain in the bottom stream, which is preferably recycled to step (a). The second normally liquid stream may preferably be recycled in part or in total to step (a), subject to purification and potential removal of side products. More preferably, the ratio of the ethylenically unsaturated acid in the first liquid (overhead) stream versus the second liquid (bottom) stream is in the range of from 30:70 to 90:10, again more preferably in the range of from 60:40 to 80:20.

In step (c), the first liquid product stream obtained in step (b) is further separated into a stream comprising the ethylenically unsaturated acid and a stream comprising the reversible diene adducts. This is preferably also done in a distillative separation. In the case of 1,3-butadiene, the reversible diene adducts and the pentenoic acid mixture have sufficiently different boiling ranges to allow a complete separation in a simple distillation column. The stream comprising the reversible diene adducts may however still include a small amount of ethylenically unsaturated acid.

In step (d), the stream comprising the reversible diene adducts is recycled to step (a). Alternatively, the reversible diene adducts are converted back to the conjugated diene and the ethylenically unsaturated acid. For this conversion, the reversible diene adducts are preferably contacted with a suitable catalyst before recycling the obtained conjugated diene and the unsaturated acid back to the process. Any catalyst suitable for the conversion may be applied, such as heterogeneous or homogeneous palladium catalysts. An example of a suitable palladium catalyst is the catalyst system as described for step (a). The obtained conjugated diene is then preferably recycled to step (a), whereas the ethylenically unsaturated acid may be recycled to step (a) as well, or combined with the stream comprising the ethylenically unsaturated acid obtained in step (c).

Specific side-products of the subject process include the Diels-Adler products formed from the conjugated diene and the ethylenically unsaturated acid acting as dienophile. In the case of 1,3-butadiene, the most frequently occurring Diels-Alder side product is 2-ethyl cyclohexene carboxylic acid (further referred to as ECCA), i.e. the Diels-Alder adduct of 1,3-butadiene and 2-pentenoic acid. Such Diels-Alder adducts can usually not be reverted into their educts under the conditions of the carbonylation reaction, and hence are not considered as reversible diene adducts within the context of this specification. They may suitably be removed in step (c) or (d).

The subject process permits to react conjugated dienes with carbon monoxide and a co-reactant. The conjugated diene reactant has at least 4 carbon atoms. Preferably the diene has from 4 to 20 and more preferably from 4 to 14 carbon atoms. However, in a different preferred embodiment, the process may also be applied to molecules that contain conjugated double bonds within their molecular structure, for instance within the chain of a polymer such as a synthetic rubber. The conjugated diene can be substituted or non-substituted. Preferably the conjugated diene is a non-substituted diene. Examples of useful conjugated dienes are 1,3-butadiene, conjugated pentadienes, conjugated hexadienes, cyclopentadiene and cyclohexadiene, all of which may be substituted. Of particular commercial interest are 1,3-butadiene and 2-methyl-1,3-butadiene (isoprene), of which 1,3-butadiene is most preferred. In the case of the carbonylation of 1,3-butadiene, step (a) results in pentenoic acid with high selectivity. This makes the process particularly suitable for adding a further reaction step, such as a further carbonylation to adipic acid.

Suitable sources of palladium for step (a) include palladium metal and complexes and compounds thereof such as palladium salts; and palladium complexes, e.g. with carbon monoxide or acetyl acetonate, or palladium combined with a solid material such as an ion exchanger. Preferably, a salt of palladium and a carboxylic acid is used, suitably a carboxylic acid with up to 12 carbon atoms, such as salts of acetic acid, propionic acid and butanoic acid. A very suitable source is palladium (II) acetate.

Any bidentate diphosphine that forms an active carbonylation catalyst with palladium may be used in the subject process. Preferably, a bidentate diphosphine ligand of formula R¹R²P—R—PR³R⁴ is employed, in which ligand R represents a divalent organic bridging group, and R¹, R², R³ and R⁴ each represent an organic group that is connected to the phosphorus atom through a tertiary carbon atom due to the higher activity and/or selectivity found with such catalysts in both reaction steps. Yet more preferably, R represents an aromatic bidentate bridging group that is substituted by one or more alkylene groups, and wherein the phosphino groups R¹R²P— and —PR³R⁴ are bound to the aromatic group or to the alkylene group due to the observed high stability of these ligands. Most preferably R¹, R², R³ and R⁴ are chosen in such way, that the phosphino group PR¹R² differs from the phosphino group PR³R⁴.

The ratio of moles of a bidentate diphosphine per mole atom of palladium is not critical. Preferably it ranges from 0.5 to 100, more preferably from 0.8 to 10, yet more preferably from 0.95 to 5, yet more preferably in the range of 1 to 3, again more preferably in the range of 1 to 2, and yet more preferably in the range of 1 to 1.5. In the presence of oxygen, slightly higher than stoichiometric amounts are beneficial. The source of anions preferably is an acid, more preferably a carboxylic acid, which can serve both as catalyst component, as well as solvent for the reaction.

Again more preferably, the source of anions is an acid having a pKa above 2.0 (measured in aqueous solution at 18° C.), and yet more preferably an acid having a pKa above 3.0, and yet more preferably a pKa of above 3.6.

Examples of preferred acids include carboxylic acids, such as acetic acid, propionic acid, butyric acid, pentanoic acid, pentenoic acid and nonanoic acid, the latter three being highly preferred as their low polarity and high pKa was found to increase the reactivity of the catalyst system.

The molar ratio of the source of anions, and palladium is not critical. However, it suitably is between 2:1 and 10⁷:1 and more preferably between 10²:1 and 10⁶:1, yet more preferably between 10²:1 and 10⁵:1, and most preferably between 10²:1 and 10⁴:1 due to the enhanced activity of the catalyst system. Very conveniently the acid corresponding to the desired product of the reaction can be used as the source of anions in the catalyst. 2-, 3- and 4-pentenoic acid are particularly preferred in case the conjugated diene is 1,3-butadiene. Preferably the reaction is conducted in 2-, 3- and/or 4-pentenoic acid, since this was found to not only form a highly active catalyst system, but also was found to be a good solvent for all reaction components.

The quantity in which the complete catalyst system is used is again not critical and may vary within wide limits. Usually amounts in the range of 10⁻⁸ to 10⁻¹, preferably in the range of 10⁻⁷ to 10⁻² mole atom of palladium per mole of conjugated diene are used, preferably in the range of 10⁻⁵ to 10⁻² mole atom per mole. The process may optionally be carried out in the presence of a solvent, however preferably the acid serving as source of anions is used as solvent and as reaction solvent. Example of suitable catalyst systems as described above are those disclosed in EP-A-1282629, EP-A-1163202, WO2004/103948 and/or WO2004/103942.

The carbonylation reaction according to the present invention in step (a) is carried out at moderate temperatures and pressures. Suitable reaction temperatures are in the range of 0-250° C., more preferably in the range of 50-200° C., yet more preferably in the range of from 80-150° C.

The reaction pressure is usually at least atmospheric pressure. Suitable pressures are in the range of 0.1 to 25 MPa (1 to 250 bar), preferably in the range of 0.5 to 15 MPa (5 to 150 bar), again more preferably in the range of 1 to 9.5 MPa (5 to 95 bar) since this allows use of standard equipment. Carbon monoxide partial pressures in the range of 0.1 to 9 MPa (1 to 90 bar) are preferred, the upper range of 5 to 9 MPa being more preferred. Higher pressures require special equipment provisions, although the reaction would be faster since it was found to be first order with carbon monoxide pressure.

In the process according to the present invention, the carbon monoxide can be used in its pure form or diluted with an inert gas such as nitrogen, carbon dioxide or noble gases such as argon, or co-reactant gases such as ammonia.

Furthermore, the addition of limited amounts of hydrogen, such as 3 to 20 mol % of the amount of carbon monoxide used, promotes the carbonylation reaction. The use of higher amounts of hydrogen, however, tends to cause the undesirable hydrogenation of the diene reactant and/or of the unsaturated carboxylic acid product. The subject process further preferably comprises a further step of reacting the ethylenically unsaturated acid further with carbon monoxide and water to obtain the dicarboxylic acid. The subject process further may preferably comprise further steps of (i) converting the dicarboxylic acid to its dichloride, and (ii) reacting the dicarboxylic acid dichloride with a diamine compound to obtain an alternating co-oligomer or co-polymer.

1. A process for the carbonylation of a conjugated diene to an ethylenically unsaturated acid, comprising the steps of
(a) contacting a conjugated diene with carbon monoxide and water in the presence of a catalyst system including a source of palladium, a source of an anion and a bidentate phosphine ligand, to obtain a mixture comprising an ethylenically unsaturated acid and a reversible diene adduct comprising alkenyl ester of the conjugated diene with the ethylenically unsaturated acid;
(b) separating the obtained reaction mixture into a gaseous stream comprising unreacted conjugated diene and carbon monoxide, a first normally liquid product stream comprising at least part of the ethylenically unsaturated acid and the reversible diene adducts, and a second normally liquid stream comprising the catalyst system in admixture with the ethylenically unsaturated acid;
(c) separating the first normally liquid product stream obtained in step (b) into a stream comprising the ethylenically unsaturated acid and a stream comprising the reversible diene adducts; and
(d) recycling the stream comprising the reversible diene adducts to step (a), or converting the reversible diene adducts back to the conjugated diene and the ethylenically unsaturated acid and recycling the thus obtained conjugated diene to step (a).

2. The process of claim 1, wherein the second normally liquid stream comprising the catalyst system in admixture with ethylenically unsaturated acid obtained in step (b) is recycled to step (a).

3. The process of claim 1, wherein the separation of step (b) is a distillative operation.

4. The process of claim 3, wherein the distillative separation of the first and second liquid streams is performed as flash separation under reduced pressure.

5. The process of claim 4, wherein the flash operation is performed in a film evaporator.

6. The process of claim 5, wherein the film evaporator is a falling film or wiped film evaporator.

7. The process of claim 1, wherein the separation in step (c) is performed as distillative operation.

8. The process of claim 1, wherein in step (d) the reversible diene adducts are converted by contacting them with a suitable catalyst.

9. The process of claim 1, wherein the water concentration in step (a) is maintained at from 0.001% to less than 3% by weight of water, calculated on the overall weight of the liquid reaction medium.

10. The process of claim 1, wherein the ethylenically unsaturated acid of step (a) is employed as solvent for the process.

11. The process of claim 1, wherein the conjugated diene is 1,3-butadiene.

12. The process of claim 1, wherein the bidentate diphosphine ligand of formula R¹R²P—R—PR³R⁴ is employed, in which ligand R represents a divalent organic bridging group, and R¹, R², R³ and R⁴ each represent an organic group that is connected to the phosphorus atom through a tertiary carbon atom.

13. The process of claim 1, comprising a further step of reacting the ethylenically unsaturated acid further with carbon monoxide and water to obtain the dicarboxylic acid.

14. The process of claim 13, comprising the further steps of (i) converting the dicarboxylic acid to its dichloride, and (ii) reacting the dicarboxylic acid dichloride with a diamine compound to obtain an alternating co-oligomer or co-polymer.

15. The process of claim 1, wherein a feed is employed containing the conjugated diene in admixture with alkenes and/or alkynes, comprising contacting the feed with carbon monoxide and water in the presence of a catalyst system including a source of palladium, a source of an anion and a bidentate phosphine ligand to obtain a mixture depleted of the conjugated diene, and comprising the ethylenically unsaturated acid and reversible diene adducts comprising alkenyl ester of the conjugated diene with the ethylenically unsaturated acid.

16. The process of claim 15, comprising the step of separating the mixture obtained into a stream containing the alkenes and/or alkynes, and a stream comprising the ethylenically unsaturated acid and reversible diene adducts in admixture with the catalyst system.
